(19) United States
(12) Patent Application Publication
(10) Pub. No.: US 2009/0271272 A1
(43) Pub. Date: Oct. 29, 2009

(54) Electronic Marketing System

(76) Inventors: Scott M. Berkowitz, Beachwood, OH (US); Vladimir Mirzoyan, Cutler Bay, FL (US)

Correspondence Address: ULMER & BERNE LLP;ATTN: DIANE BELL, 600 VINE STREET, SUITE 2800, CINCINNATI, OH, 45202, US

(21) Appl. No.: 12/364,510

(22) Filed: Feb. 2, 2009

Related U.S. Application Data
(60) Provisional application No. 61/025,753, filed on Feb. 2, 2008.

(51) Int. Cl. G06Q 30/00; G06F 15/16

(52) U.S. Cl. 705/14.67; 709/206

(57) ABSTRACT

An apparatus for creating and distributing marketing materials comprises a message template and a messaging manager. The messaging template includes a suppler information field and an identity field. The supplier information field is configured to store marketing information that describes an offering of a supplier, is preapproved by the supplier, and is unalterable by an intermediary agent. The identity field is configured to store identification information associated with the intermediary agent. The messaging manager is configured to respond to a request by the intermediary agent to create a customized message for delivery to an identified recipient with which the intermediary agent has a preexisting relationship. The customized message is based at least in part upon the message template and includes both the marketing information in the supplier information field and the identification information in the identity field. The customized message indicates that the intermediary agent and supplier are affiliated.

### PRIORITY CLAIM

This application claims priority to and the full benefit of U.S. Provisional Patent Application Ser. No. 61/025,753 filed Feb. 2, 2008, titled “REAL ESTATE MARKETING SYSTEM,” and U.S. Provisional Patent Application Ser. No. 61/149,320 filed Feb. 2, 2009, titled “ELECTRONIC MARKETING SYSTEM,” each of which is incorporated by reference as if fully rewritten herein.

### TECHNICAL FIELD

This disclosure relates generally to the field of creating and distributing marketing information, and more specifically, to the field of creating and distributing marketing information to potential purchasers through the involvement of an intermediary.

### SUMMARY

An apparatus for creating and distributing marketing materials comprises a message template and a messaging manager. The message template includes a suppler information field and an identity field. The supplier information field is configured to store marketing information that describes an offering of a supplier, is preapproved by the supplier, and is unalterable by an intermediary agent. The identity field is configured to store identification information associated with the intermediary agent. The messaging manager is configured to respond to a request by the intermediary agent to create a customized message that is based at least in part on the message template. The customized message is for delivery to an identified recipient with which the intermediary agent has a preexisting relationship. The customized message includes at least both the marketing information in the supplier information field and the identification information in the identity field. The customized message indicates that the intermediary agent is affiliated with the supplier.

A method for creating marketing materials comprising the steps of accessing a request from an intermediary agent to create a customized message, accessing a message template, and creating a customized message that is based at least in part upon the message template. The customized message is for delivery to an identified recipient with which the intermediary agent has a preexisting relationship. The message template includes a supplier information field and an identity field. The supplier information filed is configured to store marketing information that describes an offering of a supplier, is preapproved by the supplier, and is unalterable by an intermediary agent. The identity field is configured to store identification information associated with the intermediary agent. The customized message includes at least both the marketing information in the supplier information field and the identification information in the identity field. The customized message indicates that the intermediary agent is affiliated with the supplier.

An article of manufacture comprises a computer-usable medium having computer readable program code for creating marketing materials stored on the medium. The computer readable program code includes instructions for accessing a request from an intermediary agent to create a customized message, accessing a message template, and creating a customized message that is based at least in part upon the message template. The message is for delivery to an identified recipient with which the intermediary agent has a preexisting relationship. The message template includes a supplier information field and an identity field. The supplier information field is configured to store marketing information that describes an offering of a supplier, is preapproved by the supplier, and is unalterable by an intermediary agent. The identity field is configured to store identification information associated with the intermediary agent. The customized message includes at least both the marketing information in the supplier information field and the identification information in the identity field. The customized message indicates that the intermediary agent is affiliated with the supplier.

An apparatus for creating marketing materials comprises means for accessing a request from an intermediate agent to cerate a customized message, means for accessing a message template, and means for creating a customized message that is based at least in part on the message template. The customized message is for delivery to an identified recipient with which the intermediary agent has a preexisting relationship. The message template includes a supplier information field and an identification field. The supplier information field configured to store marketing information that describes an offering of a supplier, is preapproved by the supplier, and is unalterable by an intermediary agent. The identity field is configured to store identification information associated with the intermediary agent. The customized message includes at least both the marketing information in the supplier information field and the identification information in the identity field. The customized message indicates that the intermediary agent is affiliated with the supplier.

A method for creating marketing materials comprises a step for accessing a request from an intermediary agent to create a customized message, a step for accessing a message template, and a step for creating a customized message that is based at least in part upon the message template. The customized message is for delivery to an identified recipient with which the intermediary agent has a preexisting relationship. The message template includes a supplier information field and an identity field. The supplier information filed is configured to store marketing information that describes an offering of a supplier, is preapproved by the supplier, and is unalterable by an intermediary agent. The identity field is configured to store identification information associated with the intermediary agent. The customized message includes at least both the marketing information in the supplier information field and the identification information in the identity field. The customized message indicates that the intermediary agent is affiliated with the supplier.

### BRIEF DESCRIPTION OF THE DRAWINGS

FIG. 1 is a block diagram of an electronic marketing system;

FIG. 2 is a block diagram of an electronic marketing system;

FIG. 3 is a schematic view of a webpage;

FIG. 4 is a flow diagram of a method for using a marketing system;

FIG. 5 is a flow diagram of a method for using a marketing system; and

FIG. 6 is a flow diagram of a method for using a marketing system.

### DETAILED DESCRIPTION

The disclosed subject matter relates to systems and methods for creating and distributing marketing material to generate leads for sales of goods and services. The disclosure includes, but is not limited to, computer or software implementations of such systems and methods. As used in this application, the terms “component,” “system,” and the like refer to a computer-related entity including hardware, software, or firmware. For example, a component can be a process running on a processor, a processor, an object, an executable, a program, or a computer. Also, a component can be both an application running on a server and the server. One or more components can reside within a process, and a component can be localized on one computer or distributed between two or more computers.

The disclosed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (for example, hard disks, floppy disks, magnetic strips, etc.), optical disks (for example, compact disks (“CD”), digital versatile disks (“DVD”), etc.), smart cards, and flash memory devices (for example, memory sticks, key drives, etc.). Additionally it should be appreciated that a carrier wave or other data signal carrier can be employed to carry computer-readable electronic data such as those used in transmitting and receiving electronic mail (“email”) or in accessing a network such as the Internet or a local area network (“LAN”).

The term “data store,” as used herein, refers to a physical or logical entity that can store data. A data store can be, for example, a database, a table, a file, a list, a queue, a heap, a memory, a register, or any other suitable entity for storing data. A data store can reside in one logical or physical entity or can be distributed between two or more logical or physical entities.

It will be evident, however, that the disclosed systems and methods can be practiced without specific details. In other instances, well-known structures and devices are shown in block diagram form in order to facilitate description. Additionally, although specific examples set forth may use terminology that is consistent with client/server architectures or may even be examples of client/server implementations, one of ordinary skill in the art will appreciate that the roles of client and server may be reversed and that the disclosed systems and methods are not limited to client/server architectures and can be readily adapted for use in other architectures.

Exemplary methods can be better appreciated with reference to flow diagrams. While, for purposes of simplicity of explanation, the illustrated methodologies are shown and described as a series of blocks, it is to be appreciated that the methodologies are not limited by the order of the blocks, as some blocks can occur in different orders or concurrently with other blocks from those shown and described. Moreover, fewer than all of the illustrated blocks may be required to implement an example methodology. Blocks can be combined or separated into multiple components. Furthermore, additional or alternative methodologies may employ additional blocks not illustrated. While the figures illustrate various actions occurring serially, it is to be appreciated that, in different examples, various actions could occur concurrently, substantially in parallel, or at substantially different points in time.

An exemplary implementation of a system or method is directed to creating marketing information for goods and services offered for sale by a product provider. Once created, marketing information can be distributed to potential purchasers to generate sales leads for the sale of goods and services. The systems and methods use sales intermediaries to target, contact, or otherwise communicate with prospective purchasers. Sales intermediaries can have preexisting relationships with potential purchasers that allow for effective and efficient distribution of marketing material to such potential purchasers. A sales intermediary can include professionals or organizations from a wide variety of occupations and businesses. For example, a sales intermediary can include, but is not limited to, agents, brokers, dealers, resellers, distributors, advisers, managers, wholesalers, or other persons, companies, or organizations suitable for targeting or communicating with prospective purchasers.

An intermediary's ability to create and maintain relationships with prospective purchasers of goods and services can increase potentials for sales. Such relationships can allow the sales intermediary to accurately predict what types of goods and services may interest the potential purchaser. In addition, the potential purchaser can consider any communication from the intermediary as originating from a trusted source. Information from such a trusted source can attract and hold the interest of a prospective purchaser and eventually result in a sale of the goods or services. Therefore, the use of sales intermediaries can substantially increase the number of sales professions offering the product provider's goods and services for sale, thus increasing the effectiveness and efficiency of targeting and communicating with desirable prospective purchasers.

As used herein, a “supplier” or “product provider” includes, but is not limited to, any person, company, entity, organization, or party that offers products, goods, or services for acquisition or use, such as through sale, lease, rental, barter, or other appropriate transaction. Non-limiting examples of product providers include developers or managers of residential or resort properties, insurance providers, financial services providers, healthcare providers, and employment recruiters, among others.

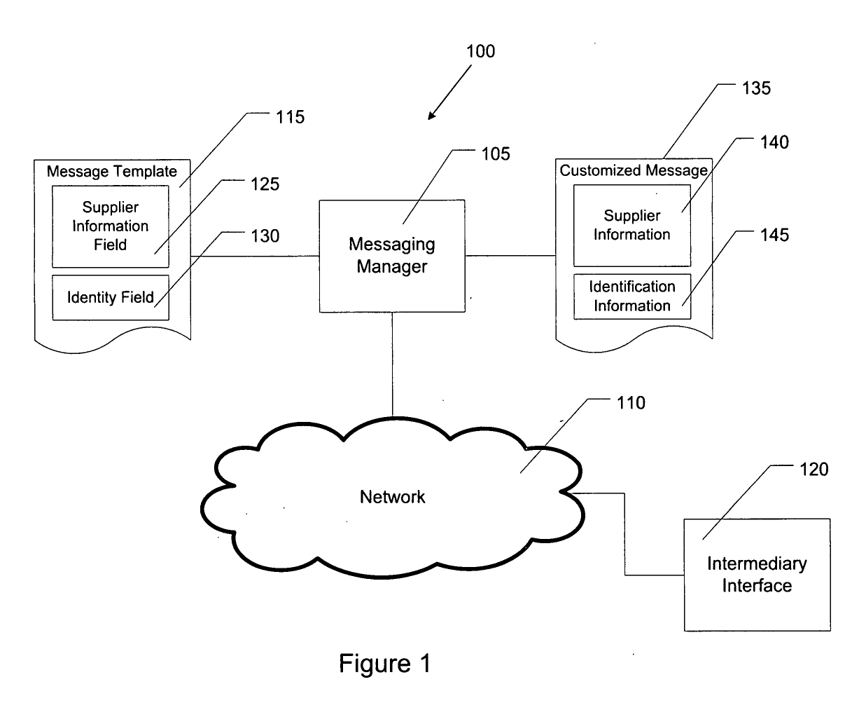

With reference to FIG. 1, an exemplary system 100 for implementing various apparatus, components, or methods can include a messaging manager 105, a network 110, a message template 115, and an intermediary interface 120. The messaging manager 105 can be for example a server, computer, software, firmware, or other suitable computer related component configured to manage data, accept commands, execute instructions, or perform other suitable computing- or communication-related tasks. The message template 115 can include a supplier information field 125 and an identity field 130. The message template 115 is configured to be accessible by the messaging manager 105.

The supplier information field 125 can be configured to store marketing information that describes a product provider or goods or services offered by a product provider. For example, the supplier information field 125 can be configured to store information in the form of digital images, text files, charts, tables, website links, animations, or any other suitable type of information that relates to the product provider or the product provider's offerings. The supplier information field 125 can be configured to store any number of files or other types of information. In one example, the supplier information field 125 can be configured to store a digital image of a product offering, text describing the offering, a digital image of a logo or trademark of the product provider, and a hyperlink to a webpage with additional product or provider information. In other examples of a message template such as the message template 115, the message template can include multiple fields for storing supplier information.

The content, format, arrangement, and layout of supplier information can be arranged to be within the sole control of the product provider. The supplier information field 125 can be further configured so that only the product provider has the rights or permissions to alter possible content, format, arrangement, or layout. Other users of the system 100 can be restricted from making any alterations related to the supplier information field 125. Such permissions and restrictions can give the product provider control over the marketing message or branding of a product offering so that such message or branding remains consistent, complete, and accurate.

The identity field 130 can be configured to store information associated with the intermediary. For example, the identity field 130 can store information in the form of digital images, text files, charts, tables, website links, animations, or any other suitable type of information that relates to the intermediary. The identity field 130 can be further configured to store any number of files or other types of information related to the intermediary. In one example, the identity field 130 can be configured to store text identifying an intermediary and the intermediary's contact information, an active link to the intermediary's email address, and a digital image of the intermediary. It will be understood that in other examples of a message template, the template can include multiple fields for storing intermediary information. In one example, the content, format, arrangement, and layout of intermediary information can be within the sole control of the intermediary. In another example, the types of information and the format and layout of such information can be in the sole control of the product provider, with the intermediary selecting the information stored by the identity field 130 based at least in part on restrictions applied by the product provider.

The intermediary interface 120 can be configured to allow a sales intermediary to interact with the messaging manager 105. The intermediary interface 120 can be for example a graphic user interface, a secure website, an audio interface, or any other suitable interface. The intermediary interface 120 can be configured to allow an intermediary to request access to the message manager 105 and further request that the messaging manager 105 create a customized message 135 based on a message template 115. The intermediary interface 120 can interact with the messaging manager 105 through a network 110. A network 110 can be for example the Internet, intranet, wide area network, local area network, virtual private network, extranet, software application, dedicated electronic connection, telephony connection, or wireless connection. Appropriate access control systems, such as challenge-response systems, username-password systems, biometric authentication, or other appropriate systems can also be employed.

When the messaging manager 105 receives a request from an intermediary to create a customized message 135, the messaging manager 105 can access the message template 115 and use the message template 115 to create a custom message 135. The messaging manager 105 can populate the supplier information field 140 with information that is preapproved and predefined by the product provider. The messaging manager 105 can further populate the identity field 145 with information provided by the intermediary, subject to any restrictions placed on the identity field 145 by the product provider. The arrangement, content, or both the arrangement and content of the resulting customized message 135 can be configured to indicate to recipients of the message 135 that the intermediary is affiliated with the product provider. Such an indication may be positively received by a prospective purchaser and result in the generation of leads and the eventual sale of goods and services.

Once the messaging manager 105 creates the customized message 135, the messaging manager 105 can receive a request from the intermediary to send the customized message 135 to one or more recipients identified by the intermediary. The intermediary can identify recipients with whom the intermediary has a preexisting relationship and whom the intermediary believes has an interest in purchasing the particular goods or services. The messaging manager 105 can use contact information supplied by the intermediary to appropriately send the message 135 to the identified recipients. The messaging manager 105 can handle the identified recipient information in a manner that restricts that information from the product provider or any other user of the system. Such restrictions may reassure the intermediary that the relationship with the identified recipient remains in the control of the intermediary agent.

The customized message 135 can be configured in any number of formats. For example, a message 135 can be in the form of a website, link to a website, email, portable document format file (PDF), multimedia messaging service (MMS), short message service (SMS), or other suitable format for delivery to an identified recipient. In addition to electronic delivery, certain identified recipients can be better targeted by delivering a physical copy of the marketing message.

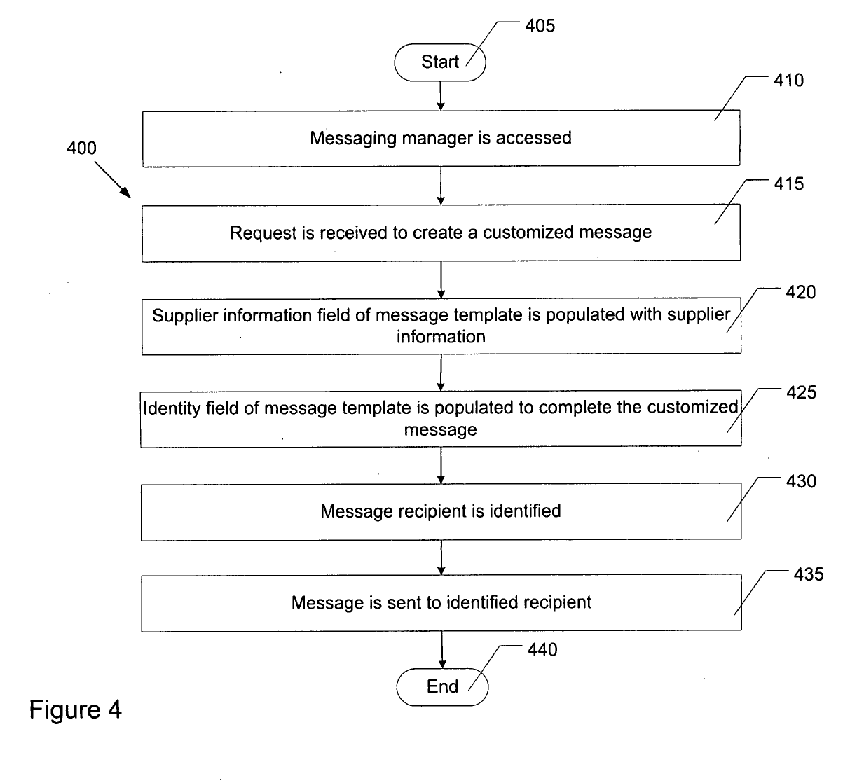

As illustrated in FIG. 4, one exemplary method 400 for using a marketing system begins 405 with a messaging manager allowing an intermediary access to the messaging manager 410. Once the intermediary is granted access, the messaging manager responds to any request by the intermediary to create a customized message 415. The messaging manager accesses a message template and populates the supplier information field of the template with supplier information 420. The messaging manager completes a customized message by populating the identity field of the of the message template with information provided by the intermediary 425. Upon completion of the customized message, the messaging manager responds to any request by the intermediary to send the customized message 430 by sending the customized message to recipients identified by the intermediary 435. Once the message is sent to the identified recipient, the method is terminated 440.

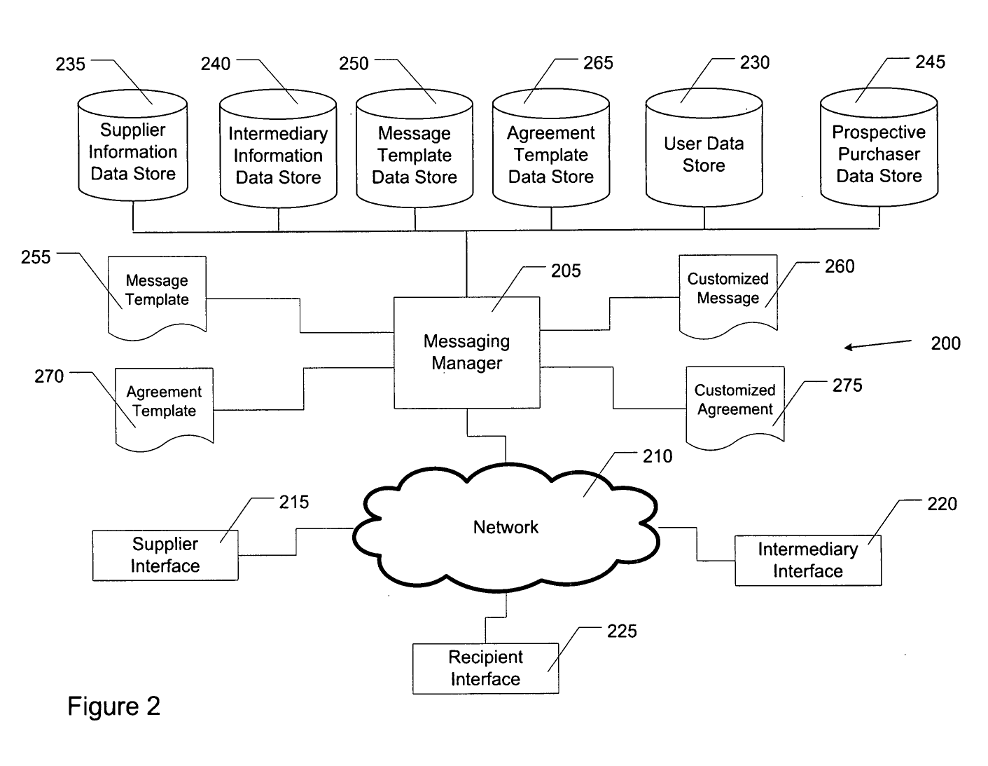

With reference to FIG. 2, a marketing system 200 can allow multiple product providers and multiple intermediaries to use the system 200 is depicted. In such a system, an administrator, who is neither a product provider nor an intermediary, can administer the system to provide services to both product providers and intermediaries to facilitate the marketing and sale of goods and services. The marketing system 200 can include a messaging manager 205, a network 210, a supplier interface 215, an intermediary interface 220, a recipient interface 225, and several data stores for storing information and data. The supplier interface 215 is configured to allow several suppliers or product providers to access the messaging manager 205, the intermediary interface 220 is configured to allow several intermediaries to access the messaging manager 205, and the recipient interface 225 is configured to allow the messaging manager 205 to send messages to multiple identified recipients.

The system 200 can allow many providers of goods and services to independently use the system 200. In one example, the system 200 allows any number of product providers to register with the system 200 to use services provided by the system 200. Once registered, the system 200 allows a product provider to store information related to the provider and goods and services offered by the provider. In addition, the system 200 allows the product provider to select or identify preferences for the use of such information and to conduct other suitable activities related to the marketing of goods and services. In one example, a product provider can access the messaging manager 205 through the supplier interface 215 and the network 210 to register as a user of the system 200. Information regarding the product provider can be gathered by the system 200 and stored in a user data store 230. Once registered with the system 200, a product provider can upload or otherwise provide the system 200 with information on goods and service offered for sale by the provider. The system 200 can store such information in a supplier information data store 235 for later use in customizing marketing messages.

The system 200 can also allow many intermediaries to register with the system 200 to use services offered by the system 200. In one example, an intermediary can access the messaging manager 205 through the intermediary interface 220 and the network 210 to register as a user of the system 200. Information on the intermediary can be stored by the system 200 in the user data store 230. Once registered with the system 200, the intermediary can provide the system 200 with information related to the intermediary, and the system 200 can store such information in an intermediary information data store 240. In addition, the intermediary can upload information regarding the intermediary's prospective purchasers. Such information can be conveniently retrieved by the intermediary when identifying recipients for marketing messages. The system 200 can store such prospective purchaser information in a prospective purchaser data store 245. An intermediary's prospective purchaser information can be restricted from all other users of the system 200 to reassure the intermediary that sole control of such information rests with the intermediary.

The user data store 230 can be configured to store information on any and all users of the system 200. For example, the user data store 230 can be configured to store a user's name, contact information, preferences, and other such suitable information. It will be readily understood by one of ordinary skill in the art from reading this disclosure that although a single user data store is shown and described, a system can include many user data stores. In one configuration, individual data stores can be included for each class of user. Information on product providers can be stored in one data store, while all information on intermediaries can be stored in a second data store. In addition, information on each product provider and intermediary can be stored in a separate data store. Suitable software and hardware security protocols and methods can be implemented to appropriately restrict access to portions of data stores based on identity and permissions of a user. Additionally or alternatively, a message template can provide one of a variety of aesthetic layouts, formats, and other features that can be preselected or predefined by those supplying content or controlling the system.

The system 200 can include a message template data store 250 for storing any number of message templates 255. Similar to previous descriptions, a messaging template 255 can include fields for storing product provider and intermediary information. In one example, a message template 255 can be defined or created by a product provider that is registered with a system 200 for marketing the specific goods and services offered by the product provider. In another example, message templates 255 can be defined or create by a system administrator for use by any registered user of the system 200. The messaging manager 205 can retrieve a message template 255 from the message template data store 250, and the fields of the message template 255 can be populated from the supplier information data store 235 and the intermediary information data store 240. Once the messaging manager 205 populates the fields of the message template 255, a customized message 260 is created.

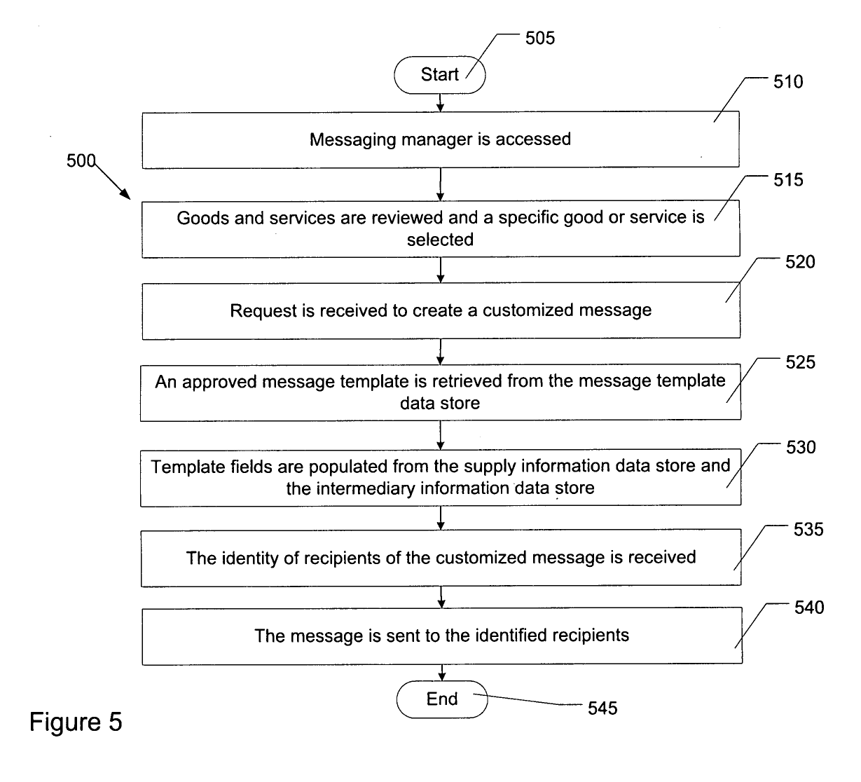

As illustrated in FIG. 5, in one exemplary method 500 for using a marketing system, the method is initiated 505 by the system allowing a registered intermediary to access the messaging manager 510. The messaging manager receives a request from the intermediary to search or reviews goods and services offered by registered product providers. The intermediary selects a good or service that may be of interest to one or more of the intermediary's prospective purchasers 515. The messaging manager receives a request from the intermediary to create a customized message 520. The messaging manager retrieves a messaging template approved by the product provider from the message template data store 525. The messaging manager populates any supplier information fields of the message template with approved information from the supplier information data store and populates any identity fields of the message template with information for the intermediary information data store to create a customized message 530. The messaging manager receives the identity of recipients for the customized message from the intermediary 535. The messaging manager sends the message to the identified recipients 540 and the method is terminated 545.

Referring again to FIG. 2, the system 200 can include functionality to create a binding agreement between product providers and intermediaries to facilitate the marketing of goods and services. The system 200 further can include an agreement template data store 265 that stores templates 270 for contractual agreements such as commission agreements, confidentiality agreements, or other suitable legally binding agreements executed between a product provider and a sales intermediary. An agreement template 270 can be a text file that can include a number of fields for storing information such as name of parties and prospective purchaser. The agreement template 270 can include language intended to bind two or more parties upon execution of the agreement

In one example, an agreement template 270 binds the product provider to pay a commission to an intermediary should a customized message 260 sent to a prospective prospect identified by the intermediary result in a sale of a product. Such a commission agreement template 270 can include fields for the product provider's name, the intermediary's name, the specific product marketed in a customized message, and the prospective purchaser's name. When a customized message 260 is created and sent, the messaging manager 205 can populate all fields of the commission agreement template 270 with information stored in the supplier information data store 235, the intermediary information data store 240, the user data store 230, and the prospective purchaser data store 245 to create a customized agreement 275. The customized agreement 275 can be executed either electronically or manually. A product provider or intermediary may permit the system 200 to include an electronic signature upon the creation of a customized agreement 275, or the product provider or intermediary may request that the party actively execute each agreement separately at the time of creation. Executed agreements can be communicated to one or more parties through an electronic data exchange.

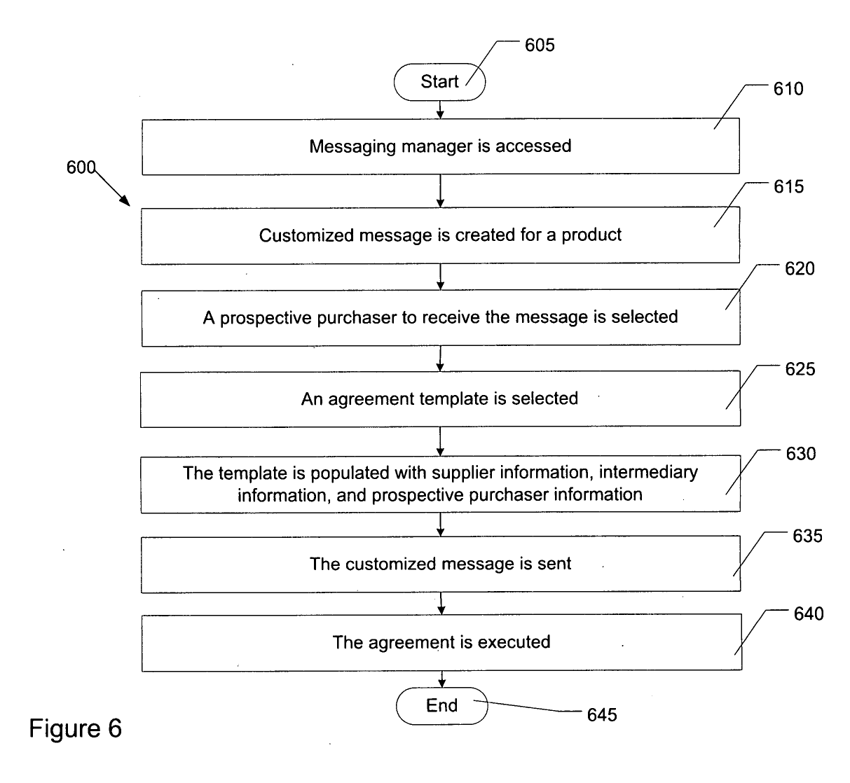

As illustrated in FIG. 6, in one exemplary method 600 of using a marking system, the method is initiated 605 when the system allows an intermediary to access the messaging manager 610. The system creates a customized message based on a product identified by the intermediary 615. The system receives the intermediary's selection of a prospective purchaser to receive the message 620. An agreement template is selected from the agreement template database 625, and the system populates the template with supplier information, intermediary information, and prospective purchaser information 630. The system sends the customized message to the prospective purchaser 635. The agreement is executed and the supplier is legally bound to pay the intermediary a commission if the prospective purchaser purchases the product 640, and the method is terminated 645.

In an exemplary implementation of a marketing system the interaction of product providers and intermediaries with the system is generally facilitated by a publically accessible website. To facilitate understanding of the subject matter, such an implementation will be described so that product providers are developers of secondary and retirement residential properties, and intermediaries are real estate brokers with an existing local client base. In one example, an introductory webpage provides an explanation of the website and details services offered by the marketing system. The introductory webpage can include images of featured properties and news items related to the secondary home market. The introductory webpage also can include a login portion where registered developers and brokers can enter a username and password to gain access to the remainder of the website. The introductory webpage also can include links for interested developers and brokers to register with the system. Once registered, a developer can upload information regarding properties for sale, select preferences on how the information can be used in marketing messages, and select preferences with regard to how agreements are formed with brokers. Registered brokers can upload information regarding the broker, upload the broker's client lists, and select preferences on how the broker information may be used in marketing messages.

The system can also generate homepages for each developer or broker with information customized to each developer or broker. For example, a customized developer homepage can include links to marketing information that the developer has provided to the system, links to messages left by other users of the system, or links to developer services and functionality provided by the system. A customized broker homepage can include links to properties that the broker has an interest in and links to broker services and functionality offered by the system.

One example of a broker service offered by the system is a survey tool. The survey tool allows a broker to develop a survey message that can be sent to any or all of the broker's clients. The survey can include questions such as: are you interested in receiving information on a second home, what geographic locations would you consider for a second home, etc. The system can arrange the survey in an email format and send the email to all clients identified by the broker. The email is formatted so that it appears to originate from the broker's email account. Such an email will be perceived by the recipient as originating from a trusted source, substantially increasing the chances that the recipient will open the email and complete the survey. When a client completes and returns the survey, the results of the survey are stored in a client data store on the system so that the broker can use the preferences revealed by the completed surveys to more accurately target clients with future marketing messages. The survey results, along with all the client information, can be configured so that only the broker may view or use the information.

Another example of a broker service is providing the broker with search functionality across all properties registered with the system. To find a property that may appeal to a specific client or a group of clients, a broker can conduct searches based on a number of criteria such as type of home, type of community, geographic location, price, amenities, number of bedrooms, etc. Such search criteria can be derived from the results of surveys completed by the broker's clients or the broker's general knowledge of the clients. Once a property or group of properties is identified, the system can present the broker with a number of options. For example, one option can be for the broker to access the broker's client list and identify for the system what clients will receive marketing messages regarding the properties. The system can create a marketing message based on the developer-defined template by populating fields with the developer's marketing information and the broker's information. The message can be sent to the client in a form of a personalized email to again indicate that the information is from the trusted broker.

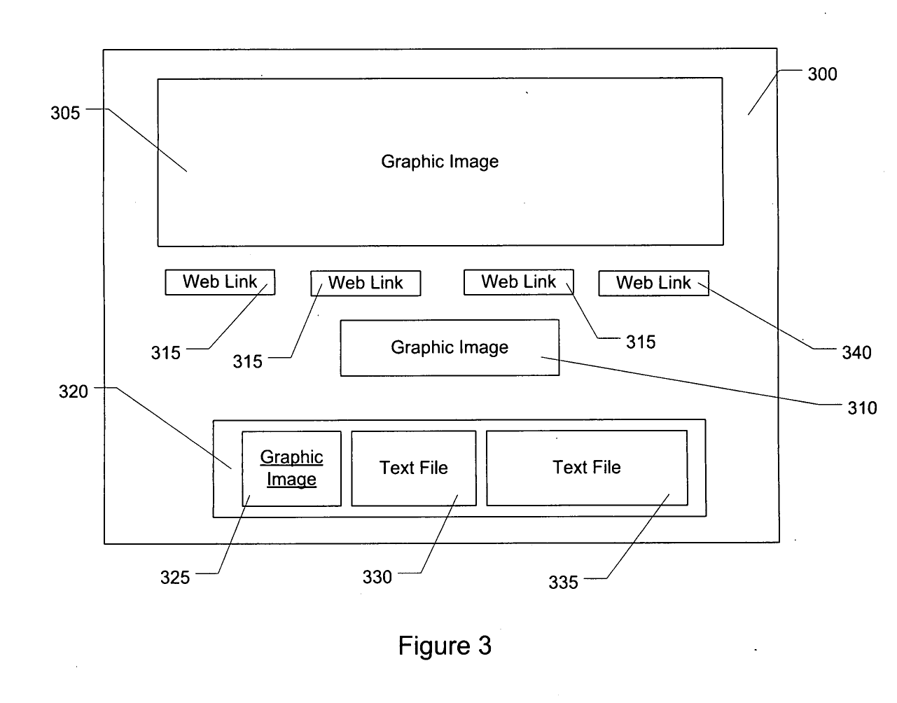

In another example, the system can create a webpage that can include the developer's marketing material and broker information formatted to indicate that the broker is affiliated with the developer. A link to the webpage can be emailed to clients identified by the broker. With reference to FIG. 3, in one example the webpage 300 can include a graphic image of the property 305, a graphic image of the developer's logo 310, and several web links 315 to take the viewer to additional webpages that display the developer's marketing material. The webpage 300 also can include a field 320 for broker information.

In an example, the broker information field 320 can include a digital image of the broker 325, the text file of the broker's contact information 330, and a text file of a personalized message 335 from the broker to the client. The webpage 300 can also include a web link 340 through which the client can request additional information or a follow-up phone call regarding the property. Whether the additional information or follow-up phone call originates from the developer or broker, the broker will be informed of the request for addition information so that the broker is kept abreast of the activities of the client. In one example, an email is sent to the broker to inform the broker that a client requested additional information on a property. Other possible implementations include HTML-formatted email, RTF-formatted email, traditional email, or other suitable formats.

Another service offered by the system is the creation of a referral fee agreement between the developer and broker. The referral fee agreement can be created when the marketing message is created. The referral fee agreement can be displayed to the broker so that the broker may review the terms of the agreement before deciding whether to send the message to the client. Based on preferences of both the developer and broker, the agreement can be executed at the time the marketing message is sent to the client or at a time when a client requests more information based on a received marketing message. In addition, the broker and developer may give permission to the system to execute the contract upon the completion of a certain step, such as the sending of a marketing message to a client or a request by a client for additional information on a property.

One example of a developer service offered by the system is tools for formatting marketing content. Such a service provides the developer with the ability to define templates for marketing content by uploading digital images, text files, webpages, etc. and arranging the content into the defined templates. Through such a service, the developer can form templates and marketing materials to be used by brokers in creating messages to be sent to prospective purchasers. The service allows the developer to control the content that is sent to prospective purchasers so that the developer's marketing message remains complete and consistent across all brokers using the system.

Another example of a developer service is a statistical analysis tool. Such a tool can provide developers with specific statistical analysis of the developer's properties and general statistical analysis of the industry. The system can provide statistical analysis regarding the number of leads generated for the developer's properties, sales commissions earned by brokers, number of times developer's properties have been viewed, number of times a developer's property has been included in a marketing message, and so on. In addition, the system can provide developers with general statistics such as most frequent search criteria, most popular geographic area searched, price distribution for properties sold, average leads generated per property, and so on.

Other services provided by the system include updates to past marketing messages. Once a set of search criteria is used to produce results for marketing messages, follow-up messages can be generated when additional properties are added to the system that meet the search criteria. For example, if a broker search indicates that a client of a broker is interested in a cluster home in south Florida located on a golf course, each time a property is added to the system that meets that criteria, the broker is informed of the addition. The broker may then decide if a marketing message should be sent to the client describing the newly added property. In addition, if there is a substantial change to a property that was the object of a past marketing message, the broker may be informed of the change. For example, if there is a price reduction in a property previously sent to a client, the broker will be informed and have the option of sending another marketing message to the client detailing the reduction in price.

Searches by brokers may also motivate developers to add additional properties to the system. In a situation where a developer has not listed all available properties with the system, the criteria of broker searches can be provided to developers. If a developer has a property that matches a search criterion, the developer can add the property to the system and a message is directed to the broker informing the broker of the addition.

In another exemplary implementation of the marking system, access to the properties listed on the system can be made generally available to brokers regardless of whether the broker has registered with the system. In such an implementation, a broker can conduct a search of properties based on desired criteria. When the results of the search are returned, the broker will be prompted to register with the system to take advantage of the system's ability to generate a marketing message and deliver that message to clients of the broker.

Although systems and methods have been described and illustrated herein as implemented for use by real estate brokers and developers, it will be readily understood that such systems and methods can be implemented for used by any number of product providers and intermediaries. For example, systems and methods can be configured for use by insurance carriers and insurance brokers and agents; financial services providers and financial advisors; healthcare providers and healthcare brokers; and employers and employment recruiters. In one example, the specialty or high risk insurance market may be serviced by a small number of insurance carriers. Because such carriers may not have captive agents, it can be beneficial to expand marketing efforts by using large numbers of local agents that have preexisting relationships with local clients. These clients may have a need for specialty or high risk insurance that cannot be filled by the local agent. The systems and methods as described herein can facilitate the marketing of specialty or high risk insurance product by local insurance brokers and agents to clients in need of such products.

What has been described above includes examples. It is, of course, not possible to describe every conceivable combination of components or methodologies for purposes of describing the disclosed systems and methods, but one of ordinary skill in the art may recognize that many further combinations and permutations are possible. Accordingly, the disclosed systems and methods are intended to embrace all such alterations, modifications, and variations. In particular and in regard to the various functions performed by the above described components, apparatus, systems and the like, the terms (including a reference to a “means”) used to describe such components are intended to correspond, unless otherwise indicated, to any component which performs the specified function of the described component (for example, a functional equivalent), even though not structurally equivalent to the disclosed structure, which performs the function in these illustrated examples.

In addition, while a particular feature may have been disclosed with respect to only one of several implementations, such feature can be combined with one or more other features of the other implementations as may be desired and advantageous for any given or particular application. Furthermore, to the extent that the terms “includes,” and “including” and variants thereof are used, these terms are intended to be inclusive in a manner similar to the term “comprising.”

What is claimed is:

1. An apparatus for creating and distributing marketing materials, comprising:
a message template that includes
a supplier information field configured to store marketing information that
describes an offering of a supplier,
is preapproved by the supplier, and
is unalterable by an intermediary agent, and
an identity field configured to store identification information associated with the intermediary agent;
a messaging manager configured to
respond to a request by the intermediary agent to create a customized message for delivery to an identified recipient with which the intermediary agent has a preexisting relationship and
create a customized message that is based at least in part upon the message template and that includes at least both
the marketing information in the supplier information field and
the identification information in the identity field; and
wherein the customized message indicates that the intermediary agent is affiliated with the supplier.

2. A method for creating marketing materials, comprising the steps of:
accessing a request from an intermediary agent to create a customized message for delivery to an identified recipient with which the intermediary agent has a preexisting relationship;
accessing a message template that includes
a supplier information field configured to store marketing information that
describes an offering of a supplier,
is preapproved by the supplier, and
is unalterable by an intermediary agent, and
an identity field configured to store identification information associated with the intermediary agent;
creating a customized message that is based at least in part upon the message template and that includes at least both
the marketing information in the supplier information field and
the identification information in the identity field;
wherein the customized message indicates that the intermediary agent is affiliated with the supplier.

3. An article of manufacture, comprising:
a computer-usable medium having computer readable program code for creating marketing materials stored thereon, the computer readable program code including instructions for:
accessing a request from an intermediary agent to create a customized message for delivery to an identified recipient with which the intermediary agent has a preexisting relationship;
accessing a message template that includes
a supplier information field configured to store marketing information that
describes an offering of a supplier,
is preapproved by the supplier, and
is unalterable by an intermediary agent, and
an identity field configured to store identification information associated with the intermediary agent; and
creating a customized message that is based at least in part upon the message template and that includes at least both
the marketing information in the supplier information field and
the identification information in the identity field;
wherein the customized message indicates that the intermediary agent is affiliated with the supplier.

4. An apparatus for creating marketing materials, comprising:
means for accessing a request from an intermediary agent to create a customized message for delivery to an identified recipient with which the intermediary agent has a preexisting relationship;
means for accessing a message template that includes
a supplier information field configured to store marketing information that
describes an offering of a supplier,
is preapproved by the supplier, and
is unalterable by an intermediary agent, and
an identity field configured to store identification information associated with the intermediary agent; and
means for creating a customized message that is based at least in part upon the message template and that includes at least both
the marketing information in the supplier information field and
the identification information in the identity field;
wherein the customized message indicates that the intermediary agent is affiliated with the supplier.

5. A method for creating marketing materials, comprising:
a step for accessing a request from an intermediary agent to create a customized message for delivery to an identified recipient with which the intermediary agent has a preexisting relationship;
a step for accessing a message template that includes
a supplier information field configured to store marketing information that
describes an offering of a supplier,
is preapproved by the supplier, and
is unalterable by an intermediary agent, and
an identity field configured to store identification information associated with the intermediary agent; and
a step for creating a customized message that is based at least in part upon the message template and that includes at least both
the marketing information in the supplier information field and
the identification information in the identity field;
wherein the customized message indicates that the intermediary agent is affiliated with the supplier.
